(19) United States
(12) Patent Application Publication
(10) Pub. No.: US 2006/0244326 A1
(43) Pub. Date: Nov. 2, 2006

(54) Motor

(75) Inventor: Takehito Tamaoka, Kyoto (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: Nidec Corporation, Kyoto (JP)

(21) Appl. No.: 11/380,659

(22) Filed: Apr. 28, 2006

(30) Foreign Application Priority Data
Apr. 28, 2005 (JP) JP2005131318

(51) Int. Cl. H02K 7/00; H02K 5/16

(52) U.S. Cl. 310/90; 360/99.08; 310/67 R

(57) ABSTRACT

In an electric motor provided with a bearing mechanism utilizing fluid dynamic pressure, it is an object of the invention to restrain synergy superimposition and synergy superimposition resonance of vibration caused by deterioration of roundness of the sleeve and harmonic vibration caused by number of poles or number of phase. In a bearing mechanism which is provided in a motor and which utilizes fluid dynamic pressure of lubricant oil, five straight grooves substantially parallel to the center axis J1 are formed in an outer surface of a sleeve at substantially equal distances from one another in the circumferential direction. The grooves and an inner surface of a sleeve housing form flow paths for circulating the lubricant oil. In the motor, the number of grooves of the sleeve is a relative prime with respect to the number of phase (three phase) of drive current of the motor and the number of poles (eight poles) of the field magnet. With this, it is possible to suppress the synergy superimposition and the synergy superimposition resonance of vibration caused by deterioration of the roundness of sleeve and vibration caused by number of poles of the motor or the number of phase of the drive current.

### BACKGROUND OF THE INVENTION

1. Technical Field

The present invention relates to an electric motor provided with a bearing mechanism utilizing fluid dynamic pressure.

2. Description of the Related Art

Conventionally, a recording disk drive such as a hard disk drive includes a spindle motor (“motor,” hereinafter) for rotating and driving a recording disk. In recent years, a bearing mechanism utilizing fluid dynamic pressure is employed as one of bearing mechanisms of a motor. In the bearing mechanism utilizing such fluid dynamic pressure, a thrust bearing portion and a radial bearing portion are constituted between a shaft (and a portion connected to the shaft) and a sleeve into which the shaft is inserted.

For example, a housing and a bearing sleeve fixed to an inner peripheral surface of the housing (both are collectively called “sleeve unit,” hereinafter), a shaft member inserted into the sleeve unit, and a thrust member for closing an opening of the lower sleeve unit constitute a dynamic pressure bearing apparatus. Three grooves in the axial direction are formed in an outer periphery of the bearing sleeve in the circumferential direction at equal distances from one another. In an inner space of the housing, lubricant oil is circulated through the axial grooves, thereby preventing pressure of lubricant oil from locally becoming negative pressure, and to prevent lubricant oil bubbles, lubricant oil leakage, rotor portion vibration and the like generating.

Alternatively, a dynamic pressure type bearing is formed at its outer periphery with two grooves extending along the axial direction, and when the dynamic pressure type bearing is inserted and assembled into the housing, these grooves function as venting passages for securing passage of air between outside and space surrounded by the dynamic pressure type bearing and the bottom plate which closes the lower opening of the housing.

Due to the grooves formed in the outer side surface of the sleeve, the roundness of the sleeve is deteriorated (that is, the outer peripheral surface shape of the sleeve is deviated from a perfect circle). Therefore, the characteristics of the bearing are deteriorated, non synchronous vibration of low frequency is generated in a rotor, and NRRO (Non-repeatable Run Out: vibration that is not synchronous with the number of rotations of a rotor when the motor is operated) is deteriorated in some cases. Hence, it is preferable that the number of grooves is three so that the sleeve is deformed into a shape similar to the three arc bearing having small directional property of the rigidity of the bearing and high stability.

In recent years, recording disk drives are provided in portable music players and the like, and it is required that the recording disk drive is increased in capacity and reduced in both size and thickness. Therefore, a motor that is a drive source of the recording disk drive is also required to reduce its size, thickness and noise.

In the case of a motor, the minimum common multiple between the number of poles of a field magnet and the number of slots of a stator (36 order when 12 poles 9 slots) is the order of switching, and when high frequency obtained by multiplying the number of rotations of the rotor by the order of switching becomes equal to an eigenvalue of the motor (e.g., first Rocking mode, second Rocking mode, parallel mode (or translational mode), umbrella mode), due to the electromagnetic excitation force of switching, the rotor causes abrupt resonance phenomenon, the RRO (Repeatable Run Out: vibration of synchronous component of the rotor portion when the motor is operated) is deteriorated, Puretone (pure tone noise caused by resonance between the stator and the rotor) is increased, and reading and writing of information from and into the recording disk and utilization in the silence environment are adversely affected in some cases. Further, even when frequency of a divisor or multiple of an order of switching becomes equal to the eigenvalue of the motor, resonance is generated in some cases, and in order to restrain the electromagnetic excitation force from being generated, the shape of the motor stator is devised.

However, as the motor is reduced in size and thickness, the thickness of the sleeve must be reduced, deterioration of roundness of the sleeve caused by influence of groove formed in the outer side surface is relatively increased, and RRO vibration caused by deterioration of roundness of a sleeve and high order vibration caused in combination of electromagnetic exciting force is prone to be generated.

### BRIEF SUMMARY OF THE INVENTION

The present invention has been accomplished in view of the above problem, and in an electric motor provided with a bearing mechanism utilizing fluid dynamic pressure, it is an object of the invention to restrain synergy superimposition and synergy superimposition resonance of vibration caused by deterioration of roundness of the sleeve and harmonic vibration caused by number of poles or number of phase.

That is, when a divisor of the number of grooves formed in the sleeve and a divisor of switching order (i.e., divisor of the number of poles of the magnet or the number of slots of a stator (in other words, multiple or divisor of number of phase of drive current of the motor)) are equal to each other, vibration caused by deterioration of roundness of the sleeve and vibration caused by switching causes synergy superimposition, and when their excitation frequency coincides with the eigenvalue of the motor, synergy superimposition resonance is generated and RRO becomes especially large. Therefore, the invention provide a sleeve, a sleeve housing and an electric motor which do not generate such phenomenon.

A substantially cylindrical sleeve used in a bearing mechanism utilizing fluid dynamic pressure in an electric motor, the sleeve comprising a substantially cylindrical inner surface formed around a predetermined center axis into which a shaft is inserted, and a substantially cylindrical outer surface formed around the center axis, wherein the outer surface is provided with a plurality of straight grooves that are substantially in parallel to the center axis and that are arranged at substantially equal distances from each other with respect to a circumferential direction around the center axis, the number of grooves is a relative prime with respect to the number of phase of drive current of the motor and the number of poles of a field magnet.

A sleeve unit of a bearing mechanism that is provided in an electric motor and that utilizes fluid dynamic pressure, the sleeve unit comprises a substantially bottomed cylindrical sleeve housing, and the sleeve fixed to an inner surface of the sleeve housing.

An electric motor comprising a rotor portion having a field magnet disposed around a shaft, and a stator portion that has an armature for generating torque around the shaft between the stator portion and the field magnet, and that supports the rotor portion such that the rotor portion can rotate around the shaft, wherein one of the rotor portion and the stator portion has the sleeve unit, the other one of the rotor portion and the stator portion has the shaft that is to be inserted into the sleeve unit through working fluid.

According to the present invention, it is possible to suppress synergy superimposition and synergy superimposition resonance of vibration caused by deterioration of roundness of the sleeve and harmonic vibration caused by number of poles or number of phase. Other objects and effects of the present invention will become apparent in the following detailed description.

### BRIEF DESCRIPTION OF THE SEVERAL VIEWS OF THE DRAWINGS

FIG. 1 shows an interior structure of a recording disk drive according to a first embodiment;

FIG. 2 is a vertical sectional view showing a structure of the first embodiment;

FIG. 3 is an enlarged vertical sectional view of a portion of a motor of the first embodiment;

FIG. 4 is a plan view of a sleeve of the first embodiment;

FIG. 5 is a vertical sectional view showing a motor of a second embodiment; and

FIG. 6 is a plan view showing a sleeve of the second embodiment.

### DETAILED DESCRIPTION OF THE INVENTION

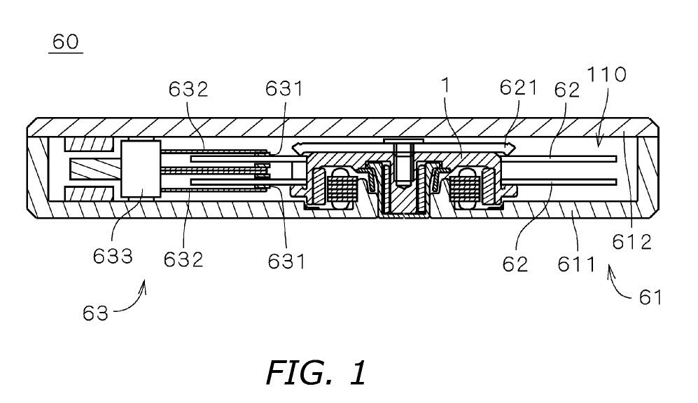

A sleeve, a sleeve unit and a spindle motor according to an embodiment of the present invention will be explained with reference to FIGS. 1 to 6. In the explanation of the embodiment of the invention, a vertical direction of each drawing is described as “vertical direction,” but this does not limit a direction in an actually mounted state.

### First Embodiment

FIG. 1 shows an internal structure of a recording disk drive 60 having an electric spindle motor 1 (“motor 1,” hereinafter) according to a first embodiment of the invention. The recording disk drive 60 is a hard disk drive. The recording disk drive 60 includes two recording disks 62 for recording information, an access mechanism 63 for writing and (or) reading information into and from the recording disk 62, a motor 1 for holding and rotating the recording disk 62, and a housing 61 for accommodating the recording disk 62, the access mechanism 63 and the motor 1 in an interior space 110.

As shown in FIG. 1, the housing 61 includes a box-like first housing member 611 having no lid. The first housing member 611 is provided at its upper portion with an opening, and the motor 1 and the access mechanism 63 are mounted on the inside bottom surface of the first housing member 611. The housing 61 also includes a plate-like second housing member 612 which covers the opening of the first housing member 611 to form the interior space 110. In the recording disk drive 60, the second housing member 612 is connected to the first housing member 611 to form the housing 61, and the interior space 110 is a clean space having little dust.

The recording disks 62 are placed on an upper side of the motor 1 and fixed to the motor 1 by a damper 621. The access mechanism 63 includes a head 631 which approaches the recording disk 62 and magnetically reads and writes information, an arm 632 which supports the head 631, and a head moving mechanism 633 which moves the arm 632, thereby relatively moving the head 631 with respect to the recording disk 62 and the motor 1. With these structures, the head 631 approaches the rotating recording disk 62 and in this state, the head 631 accesses a desired position of the recording disk 62 and writes and reads information.

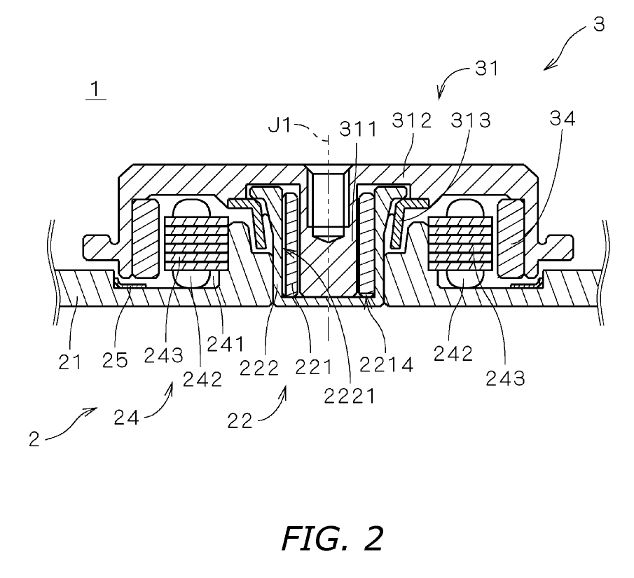

FIG. 2 is a vertical sectional view showing a structure of the motor 1 used for rotating the recording disk 62 (see FIG. 1). The motor 1 is driven by three-phase AC. As shown in FIG. 2, the motor 1 is an outer rotor type motor, and includes a stator portion 2 which is a fixed assembly and a rotor portion 3 which is a rotor assembly. The rotor portion 3 is rotatably supported through a bearing mechanism utilizing fluid dynamic pressure by lubricant oil which is working fluid. The rotor portion 3 is supported around a center axis J1 (which is also a center axis of a later-described shaft 311) of the motor 1. In the following explanation, a side close to the rotor portion 3 along the center axis J1 is defined as an upper side, and a side close to the stator portion 2 is defined as a lower side, but it is not always necessary that the center axis J1 matches with a gravity direction.

The rotor portion 3 includes a rotor hub 31 for holding various portions of the rotor portion 3, and a field magnet 34 which is mounted on the rotor hub 31 and disposed around the center axis J1. The rotor hub 31 is made of stainless steel. The rotor hub 31 includes a shaft 311 which is of a substantially cylindrical shape around the center axis J1 and which projects downward (i.e., toward the stator portion 2), a disk-like portion 312 spreading perpendicularly to the center axis J1 from an upper end of the shaft 311, and a cylindrical portion 313 downwardly projecting from the disk-like portion 312. The field magnet 34 is an annular multi-polarize magnet provided in the vicinity of an outer edge of the disk-like portion 312 of the rotor hub 31, and the number of poles (number of magnetic poles) is multiples of two (eight in this embodiment).

The stator portion 2 includes a base plate 21 which is a base portion for holding various portions of the stator portion 2, a substantially cylindrical bottomed sleeve unit 22 which is a portion of the bearing mechanism which rotatably supports the rotor portion 3. The shaft 311 of the rotor portion 3 is inserted into the sleeve unit 22 through lubricant oil. The stator portion 2 also includes an armature 24 mounted on the base plate 21 around the sleeve unit 22, and a substantially annular thrust yoke 25 disposed on a lower side of the field magnet 34.

The base plate 21 is a portion of the first housing member 611 (see FIG. 1), and is integrally formed with other portions of the first housing member 611 by pressing a iron-based metal plate member made of aluminum, aluminum alloy or magnetic or non-magnetic plate member. The thrust yoke 25 is fixed to the base plate 21 around the center axis J1. The thrust yoke 25 is a strong magnetic body which attracts the rotor portion 3 toward the base plate 21 by magnetic force between the field magnet 34 and the thrust yoke 25. The armature 24 generates a rotation force around the shaft 311 (i.e., center axis J1) between the armature 24 and the field magnet 34 disposed around the shaft 311.

The armature 24 is mounted on the base plate 21 by press fit or adhesion from above, and includes a core 241 comprising a plurality of (six in this embodiment) laminated core thin plates made of silicon copper. The core 241 includes a plurality of (12 in this embodiment) teeth 243 radially disposed around the center axis J1, and ring-like core back which supports the teeth 243 from inside (i.e., connects ends of the teeth 243 on the side of the center axis J1 and supports the ends). The thickness of each core plate which forms the core 241 is 0.1 to 0.35 mm, and more preferably 0.2 mm. Each core plate is integrally formed with a portion corresponding to the plurality of teeth 243 and the core back and thus, the teeth 243 and the core backs are magnetically connected.

The armature 24 further includes a plurality of coils 242 formed by winding conductive wires having a diameter of 0.05 to 0.3 mm (more preferably 0.1 mm) around each of the teeth 243 twice or more.

The sleeve unit 22 includes a substantially cylindrical sleeve 221 formed around the center axis J1, and a substantially bottomed cylindrical sleeve housing 222 mounted on the outer periphery of the sleeve 221. The sleeve unit 22 is mounted on the opening formed substantially at the central portion of the base plate 21. The sleeve 221 is inserted between an inner surface (“housing inner surface,” hereinafter) 2221 of the sleeve housing 222 with a slight gap therebetween, (i.e., clearance fit), and is fixed to the housing inner surface 2221 through adhesive.

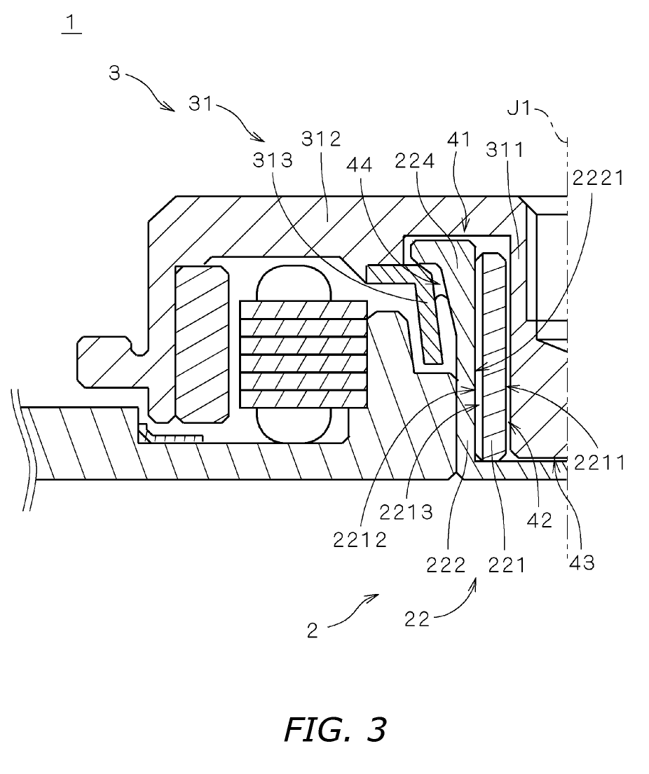

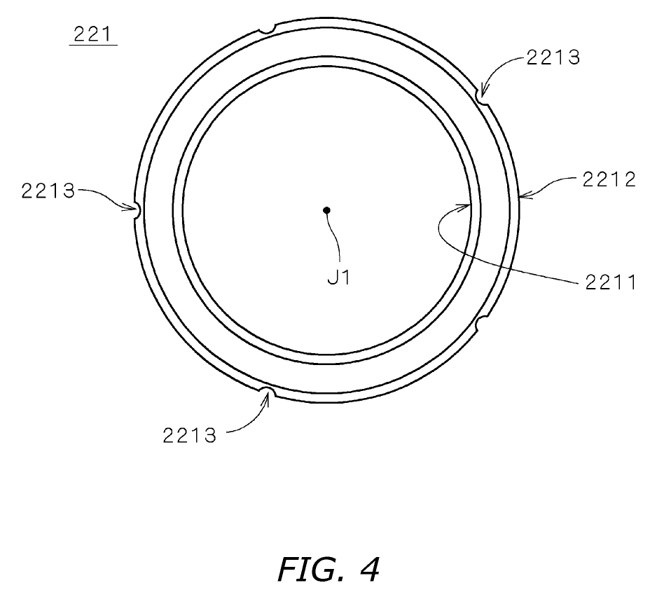

FIG. 3 is an enlarged vertical sectional view of a portion (left half in FIG. 2) of the motor 1. FIG. 4 is an enlarged plan view of the sleeve 221. As shown in FIGS. 3 and 4, the sleeve 221 has a sleeve inner surface 2211 which is of a substantially cylindrical shape formed around the center axis J1, and the shaft 311 is inserted into the sleeve inner surface 2211. The sleeve 221 also has a cylindrical sleeve outer surface 2212 formed around the center axis J1. In this embodiment, an outer diameter and an inner diameter of the sleeve 221 are 4 mm and 3 mm, respectively. The thickness (distance between the sleeve inner surface 2211 and the sleeve outer surface 2212 in the radial direction) of the sleeve 221 in the radial direction around the center axis J1 is 0.5 mm.

In the sleeve 221, five grooves 2213 extending in the direction of the center axis J1 are formed in the sleeve outer surface 2212. The grooves 2213 are formed at substantially equal distances from one another in the circumferential direction around the center axis J1. In other words, the sleeve outer surface 2212 has the five straight grooves 2213 which are substantially in parallel to the center axis J1. In this embodiment, each groove 2213 has substantially a semi-circular shape as viewed from above, and a depth of the groove 2213 in the circumferential direction around the center axis J1 is about 70 μm (i.e., about 14% of the thickness of the sleeve 221). The lower limit value of the size (depth and width) of the groove 2213 is defined such that adhesive does not enter the groove 2213 by capillary action when the sleeve 221 is mounted on the sleeve housing 222.

The sleeve 221 is a porous member. The sleeve 221 is formed in such a manner that power raw material is placed in a mold and pressurized and formed by pressing and solidifying the same and then it is sintered, the sintered member is again placed in the mold and it is compressed. As the raw material, it is possible to use various kinds of metal powder, metal compound powder, non-metal powder and the like (e.g., mixed powder of iron (Fe) and copper (Cu), mixed powder of copper, tin and lead (Pb), and mixed powder of iron and carbon (C)). The grooves 2213 of the sleeve outer surface 2212 are simultaneously and easily formed in the forming step (e.g., the pressurizing and forming step and the compression stroke after sintering) of the sleeve 221.

The sleeve housing 222 is integrally formed at its upper portion with a flange portion 224. The flange portion 224 is a projection projecting outward with respect to the center axis J1 along the outer periphery of the sleeve unit 22. An upper end of the flange portion 224 is opposed to a root of the cylindrical portion 313 in the center axis J1 at a location higher than an upper end of the cylindrical portion 313. With this, the rotor portion 3 is prevented from being separated from the stator portion 2 and pulled out upward. In other words, the cylindrical portion 313 of the rotor hub 31 and the flange portion 224 of the sleeve housing 222 prevent the rotor portion 3 from being pulled out.

Next, the bearing mechanism which rotatably supports the rotor portion 3 of the motor 1 on the stator portion 2 and which utilizes the fluid dynamic pressure will be explained. As shown in FIG. 3, in the motor 1, fine gaps are provided between a lower surface of the disk-like portion 312 of the rotor hub 31 and an end surface of an upper side of the sleeve housing 222, between the sleeve inner surface 2211 and the outer surface of the shaft 311, between the end surface of the lower side of the shaft 311 and the inner bottom surface of the sleeve housing 222, and between the outer surface of the flange portion 224 of the sleeve housing 222 and the inner surface of the cylindrical portion 313 of the rotor hub 31. In the following description, these gaps will be referred to as “upper gap 41,” “side gap 42,” “lower gap 43” and “outer gap 44,” respectively.

A plurality of flow paths are formed in the sleeve unit 22 by the housing inner side surface 2221 and the plurality of grooves 2213 formed in the sleeve outer surface 2212. The flow paths bring an upper portion and a lower portion of the sleeve 221 into communication with each other (i.e., brings the upper gap 41 and the lower gap 43 into communication). A horizontal groove 2214 (see FIG. 2) is formed in the lower end surface of the sleeve 221 for bringing the lower gap 43 and the grooves 2213 (flow paths formed thereby). In the motor 1, lubricant oil is continuously charged into the plurality of flow paths and the plurality of gaps, and a so-called full fill structure bearing mechanism is constituted.

The outer surface of the flange portion 224 of the sleeve housing 222 is an inclined surface whose outer diameter is gradually reduced downwardly, and an inner surface of the cylindrical portion 313 of the rotor hub 31 is also an inclined surface whose inner diameter is gradually reduced downwardly. The inclination of the inner surface of the cylindrical portion 313 with respect to the center axis J1 is smaller than that of the outer surface of the flange portion 224. Therefore, the width of the outer gap 44 (i.e., a distance between the outer surface of the flange portion 224 and the inner surface of the cylindrical portion 313) is gradually increased downward. With this, the interface of the outer gap 44 with respect to the lubricant oil is meniscus due to capillary action and surface tension and a tapered seal is formed, the outer gap 44 functions as an oil buffer and prevents lubricant oil from flowing out.

A groove (spiral groove for example) is formed in an upper end surface of the sleeve housing 222 for generating pressure acting toward the center axis J1 with respect to the lubricant oil when the rotor portion 3 is rotated. The upper gap 41 forms a thrust dynamic pressure bearing portion. Opposed surface of the side gap 42 are formed with grooves (e.g., herringbone grooves provided in upper and lower portions of the inner surface of the sleeve 221 with respect to the center axis J1) for generating fluid dynamic pressure in the lubricant oil. The side gap 42 forms a radial dynamic pressure bearing portion.

In this manner, in the motor 1, lubricant oil is charged into the gaps (i.e., the upper gap 41, the side gap 42, the lower gap 43 and the outer gap 44) formed between the rotor hub 31 and the sleeve unit 22 (i.e., sleeve 221 and the sleeve housing 222), and the plurality of flow paths formed by the grooves 2213 of the sleeve 221 and the housing inner side surface 2221. When the rotor portion 3 rotates, the rotor portion 3 is supported utilizing the fluid dynamic pressure caused by the lubricant oil. If the rotor portion 3 is rotated around the center axis J1 with respect to the stator portion 2, the recording disk 62 (see FIG. 1) mounted on the rotor portion 3 is rotated.

In the motor 1, the rotor portion 3 is supported by the bearing mechanism which utilizes the fluid dynamic pressure through lubricant oil in a non-contact manner. With this, the rotor portion 3 can rotate precisely with low noise. Especially in the bearing mechanism of full fill structure, since air does not exist in the bearing, bubble is not generated in lubricant oil and thus, the bubble does not cause abnormal contact between the shaft 311 and the sleeve 221. Further, leakage of lubricant oil caused by expansion of air in the bearing mechanism does not occur. In the motor 1, the sleeve 221 is porous member formed by pressurizing and forming powder raw material. Therefore, lubricant oil can be held in the bearing mechanism with high holding force, impurities such as particle in the lubricant oil is absorbed and it is possible to keep lubricant oil clean.

In the motor 1, lubricant oil pushed toward the center axis J1 in the upper gap 41 is returned to the upper gap 41 through the side gap 42, the lower gap 43, the horizontal groove 2214 and the grooves 2213. In other words, the plurality of flow paths which form the grooves 2213 and which bring the upper gap 41 and the lower gap 43 into communication with each other are utilized for circulating lubricant oil in the bearing mechanism of the motor 1. With this, pressure of lubricant oil in the upper gap 41 and the lower gap 43 become substantially equal to each other when the rotor portion 3 rotates and thus, pressure of lubricant oil in the lower gap 43 is prevented from excessively increasing, and the rotor portion 3 is prevented from excessively floating. The pressure of lubricant oil in the bearing mechanism is prevented from locally becoming negative, and bubble is prevented from being generated in the lubricant oil and the lubricant oil is prevented from leaking.

According to the motor 1, the sleeve outer surface 2212 is formed with the grooves 2213, and the roundness of the sleeve 221 is deteriorated as compared with a case in which the grooves 2213 are not formed (i.e., the outer peripheral surface shape of the sleeve 221 as viewed from above is largely deviated from perfect circle). Therefore, the side gap 42 becomes uneven in the circumferential direction, the characteristics of the radial dynamic pressure bearing portion are deteriorated and vibration may be generated, and the sleeve 221 is distorted when the rotor portion 3 rotates and vibration such as RRO may be generated. Vibration caused by deterioration of roundness (i.e., deviation from perfect circle) resonates with vibration generated due to other factor and the vibration may increase. Hence, in the motor 1, the number (five) of the grooves 2213 of the sleeve 221, the number of phase (three phases) of the drive current of the motor 1 and the number of poles (eight poles) of the field magnet 34 are relative primes with respect to each other. With this, it is possible to suppress the synergy superimposition between vibration caused by reduction of roundness of the sleeve 221 and vibration caused by the number of poles of the motor 1 (field magnet 34) or the number of phase of the drive current. As a result, in the recording disk drive 60 (see FIG. 1), vibration such as RRO of the motor 1 is prevented from increasing by the synergy superimposition resonance, and it is possible to appropriately read information from the recording disk 62, and abnormal pure tone from being generated.

In the motor 1, the five grooves 2213 are formed in the circumferential direction around the center axis J1 at substantially equal distances from one another. Thus, even if the roundness of the sleeve 221 is deteriorated and the sleeve 221 is distorted when the rotor portion 3 rotates and vibration is generated in the rotor portion 3, the sleeve 221 is prevented from being distorted unevenly in the circumferential direction, and the rotor portion 3 is prevented from unevenly vibrated in the circumferential direction.

In this manner, in the motor 1, synergy superimposition between the vibration caused by the deterioration of roundness of the sleeve 221 and the vibration caused by the number of poles of the motor 1 or the number of phase of drive current is suppressed when the rotor portion 3 rotates. Therefore, the structure of the sleeve 221 is especially suitable for a sleeve which is formed by pressurization forming having possibility that the grooves 2213 affect the roundness.

The structures of the sleeve unit 22 and the motor 1 are especially suitable for a sleeve unit and a motor in which even if the thickness of the sleeve is thin and the groove formed in the outer surface is fine, if the influence of the sleeve on the roundness is great, the thickness of the sleeve in the circumferential direction around the center axis is 0.5 mm or less. When the depth of the sleeve is relatively deep with respect to the thickness of the sleeve, the structures are especially suitable also for a sleeve unit and a motor having a sleeve in which the depth of the groove in the circumferential direction is 10% or more of the thickness of the sleeve.

The sleeve 221 has 0.5 mm thickness in the embodiment. A case in which the structure is applied to a sleeve having different thickness will be explained. For example, in a sleeve having an outer diameter of 4.2 mm, an inner diameter of 2.5 mm and a thickness of 0.85 mm, influence of a groove formed in the outer surface on the roundness of the sleeve is relatively large, and vibration due to deterioration of roundness is generated. On the other hand, in a sleeve having an outer diameter of 3.9 mm, an inner diameter of 2.0 mm and a thickness of 0.95 mm, vibration caused by deterioration of our caused by the influence of the groove is not generated almost at all. Fro a result of the experiments, the structure of the sleeve 221 is especially suitable for a sleeve in which a thickness thereof in the circumferential direction around the center axis is 0.9 mm or less.

In the bearing mechanism of the motor 1, if the number of grooves 2213 formed in the sleeve outer surface 2212 is excessively high, the amount of lubricant oil to be charged into the bearing mechanism is increased, the expansion amount of lubricant oil when the temperature rises is increased, and the temperature margin of the tapered seal in the outer gap 44 (i.e., function as oil buffer of the outer gap 44) is relatively deteriorated. In the upper gap 41, the circulation of the lubricant oil pushed toward the center axis J1 becomes fast, the pressure of lubricant oil in the lower gap 43 is reduced and the dynamic pressure becomes insufficient. Therefore, the appropriate number of grooves 2213 of the motor 1 which are 3 phase drive is five.

In the sleeve unit 22 of the motor 1, the sleeve 221 in which the plurality of grooves 2213 are formed in the sleeve outer surface 2212 are fixed to the housing inner side surface 2221 of the sleeve housing 222. With this, it is possible to easily form the circulation flow paths of lubricant oil in the bearing mechanism.

### Second Embodiment

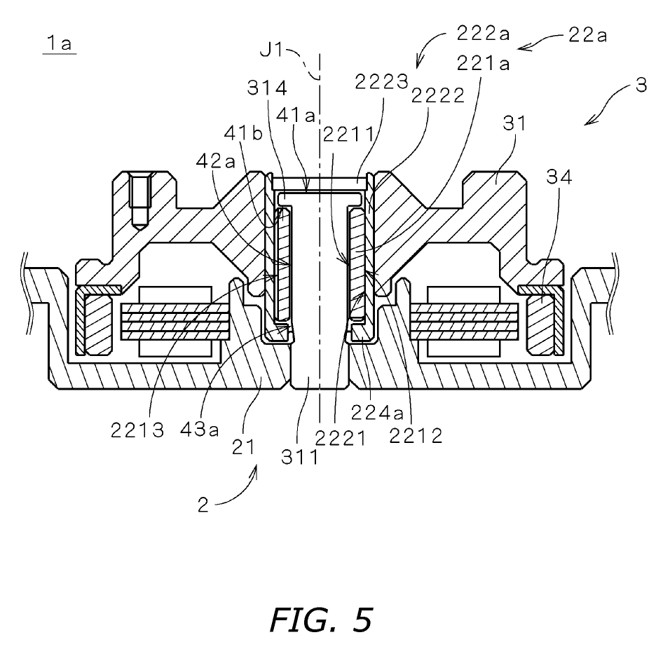

Next, a motor la of a second embodiment of the present invention will be explained. FIG. 5 is a vertical sectional view showing the motor 1a. As shown in FIG. 5, the motor 1a is substantially the same as the motor 1 shown in FIG. 2 except the structure and the shape of the bearing mechanism utilizing fluid dynamic pressure. The same symbols are added to the following explanation.

Like the first embodiment, the motor 1a is an electric motor used for rotating a recording disk of a recording disk drive, and is driven by three phase AC. As shown in FIG. 5, the motor 1 a is an outer rotor type motor like the first embodiment, and includes a stator portion 2 which is a fixed assembly, and a rotor portion 3 which is a rotary assembly. The rotor portion 3 is rotatably supported through the bearing mechanism utilizing the fluid dynamic pressure with respect to the stator portion 2 around the center axis J1 of the motor 1a.

As shown in FIG. 5, in the motor 1a, the shaft 311 is mounted in an opening formed at substantially a central portion of the base plate 21 of the stator portion 2, and the sleeve unit 22a is mounted in an opening formed at a substantially central portion of the rotor hub 31 of the rotor portion 3 unlike the first embodiment. An upper end of the shaft 311 provided on the stator portion 2 (i.e., end closer to the rotor portion 3 in the center axis J1) is provided with a disk-like thrust plate 314 spreading outward with respect to the center axis J1.

A sleeve unit 22a provided on the rotor portion 3 includes a substantially cylindrical sleeve 221a formed around the center axis J1, and a substantially bottomed cylindrical sleeve housing 222a mounted on an outer periphery of the sleeve 221a. The sleeve housing 222a includes a substantially cylindrical sidewall portion 2222 mounted on the outer periphery of the sleeve 221a, and a bottom portion 2223 for closing an upper opening of the sidewall portion 2222. In the sleeve unit 22a, the sleeve 221a is fixed to the housing inner side surface 2221 of the sleeve housing 222a through adhesive.

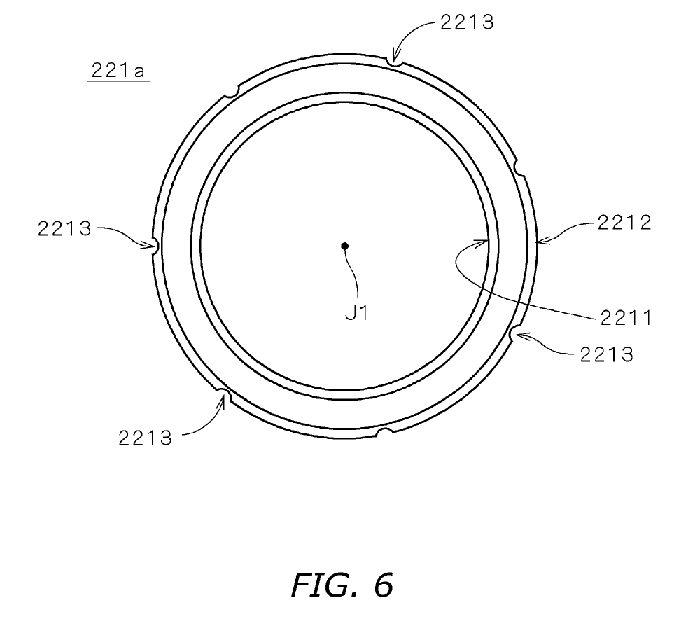

FIG. 6 is a plan view showing the sleeve 221a. As shown in FIG. 6, the sleeve 221a includes a sleeve inner surface 2211 which is a substantially cylindrical surface formed around the center axis J1 and into which the shaft 311 is inserted like the first embodiment, and a cylindrical surface sleeve outer surface 2212 formed around the center axis J1. The sleeve outer surface 2212 includes seven straight grooves 2213 which are substantially in parallel to the center axis J1. The grooves 2213 are formed in the circumferential direction around the center axis J1 at substantially equal distances from one another. In this embodiment also, like the first embodiment, the outer diameter and the inner diameter of the sleeve 221a are 4 mm and 3 mm, respectively, and the thickness thereof around the center axis J1 is 0.5 mm. The shape of each groove 2213 is substantially semi-circular as viewed from above, and the depth of the groove 2213 around the center axis J1 in the radial direction is about 70 μm (i.e., about 14% of the thickness of the sleeve 221a).

Like the first embodiment, the sleeve 221a is a porous member. The sleeve 221a is formed in such a manner that power raw material is placed in a mold and pressurized and formed by pressing and solidifying the same and then it is sintered, the sintered member is again placed in the mold and it is compressed. The grooves 2213 of the sleeve outer surface 2212 are simultaneously and easily formed in the forming step (e.g., the pressurizing and forming step and the compression stroke after sintering) of the sleeve 221a.

Next, the bearing mechanism utilizing the fluid dynamic pressure for rotatably supporting the rotor portion 3 of the motor 1a on the stator portion 2 will be explained. As shown in FIG. 5, in the motor 1a, fine gaps are provided between a lower surface of the bottom portion 2223 of the sleeve housing 222a and an upper surface of the thrust plate 314 of the shaft 311, between a lower surface of the bottom portion 2223 of the sleeve housing 222a and an upper end surface of the shaft 311, between an upper end surface of the sleeve 221a and a lower surface of the thrust plate 314, and between the sleeve inner surface 2211 and the outer surface of the shaft 311, and between the outer surface of the shaft 311 and an inner surface of a substantially annular flange portion 224a projecting from a lower end of the sleeve housing 222a toward the center axis J1. These gaps will be referred to as “first upper gap 41a,” “second upper gap 41b,” “side gap 42a” and “lower gap 43a,” respectively.

In the sleeve unit 22a, a plurality of flow paths are easily formed by the housing inner side surface 2221 and the plurality of grooves 2213 formed in the sleeve outer surface 2212. The flow paths bring the first upper gap 41a, the second upper gap 41b and the lower gap 43a into communication with each other. In the motor 1a, lubricant oil is continuously charged into the plurality of flow paths and the plurality of gaps, and a so-called full fill structure bearing mechanism is constituted.

A portion of the outer peripheral surface of the shaft 311 that is opposed to the flange portion 224a of the sleeve housing 222a is an inclined surface whose outer diameter is gradually reduced downwardly. The inner diameter of the inner peripheral surface of the flange portion 224a of the sleeve housing 222a that is opposed to the inclined surface is constant. With this, the interface of the lubricant oil in the gap (i.e., lower gap 43a) between the flange portion 224a and the shaft 311 is meniscus due to capillary action and surface tension and a tapered seal is formed, the lower gap 43a functions as an oil buffer and prevents lubricant oil from flowing out.

Grooves (spiral grooves for example) are formed in an upper end surface of the thrust plate 314 and an upper end surface of the sleeve 221a for generating pressure acting toward the center axis J1 with respect to the lubricant oil when the rotor portion 3 is rotated. The first upper gap 41a and the second upper gap 41b constitute the thrust dynamic pressure bearing portion. Opposed surfaces of the side gap 42a are formed with grooves (e.g., herringbone grooves provided vertically in the inner surface of the sleeve 221 with respect to the center axis J1) for generating fluid dynamic pressure in the lubricant oil. The side gap 42a constitutes a radial dynamic pressure bearing portion.

The flow paths formed by the grooves 2213 bring the first upper gap 41a, the second upper gap 41b and the lower gap 43a into communication with each other, and are utilized for circulating lubricant oil in the bearing mechanism of the motor 1a.

In the motor 1a, the rotor portion 3 is supported in a non-contact manner utilizing fluid dynamic pressure caused by lubricant oil charged into the gaps (i.e., the first upper gap 41a, the second upper gap 41b, the side gap 42a and the lower gap 43a) formed between the sleeve unit 22a and the shaft 311, and the flow paths formed by the housing inner side surface 2221 and the grooves 2213 of the sleeve 221a. With this, the rotor portion 3 can be rotated precisely with low noise.

Like the first embodiment, since the bearing mechanism of the motor 1a is of full fill structure, bubble is not generated in lubricant oil and thus, the bubble does not cause abnormal contact between the shaft 311 and the sleeve 221. Further, leakage of lubricant oil caused by expansion of air in the bearing mechanism does not occur. The sleeve 221a is porous member. Therefore, lubricant oil can be held in the bearing mechanism with high holding force, impurities such as particle in the lubricant oil is absorbed and it is possible to keep lubricant oil clean.

In the bearing mechanism of the motor 1a, pressure of lubricant oil in the first upper gap 41a, the second upper gap 41b and the lower gap 43a become substantially equal to each other by the flow paths formed by the grooves 2213 and the housing inner side surface 2221 of the sleeve housing 222a. Thus, the rotor portion 3 is prevented from excessively floating when the rotor portion 3 rotates. Bubbles are not produced by local negative pressure in the lubricant oil. Leakage of lubricant oil is prevented.

In the motor 1a, especially if the number of grooves 2213 of the sleeve 221a is set to seven, the number of grooves 2213 of the sleeve 221a becomes a relative prime with respect to the number of phase (three phases) of the drive current of the motor 1a and the number of poles (eight poles) of the field magnet 34. Therefore, synergy superimposition and the synergy superimposition resonance of vibration caused by deterioration of the roundness of the sleeve 221a and vibration caused by the number of poles of the motor 1a or the number of phase of the drive current can be suppressed. As a result, in a recording disk drive on which the motor 1a is mounted, vibration such as RRO of the motor 1a is prevented from being increased by the synergy superimposition resonance, and information can appropriately be read from a recording disk, and abnormal pure tone can be prevented from being generated. In the motor 1a, since the seven grooves 2213 are formed around the center axis J1 in the circumferential direction at substantially equal distances from one another. Thus, when the rotor portion 3 rotates, the rotor portion 3 is prevented from vibrating unevenly in the circumferential direction.

Like the first embodiment, the structure of the sleeve 221a is especially suitable for a sleeve formed by the pressurization forming in which the grooves 2213 may affect the roundness. The structures of the sleeve unit 22a and the motor 1a are especially suitable for a sleeve unit and a motor having a sleeve whose thickness in the radial direction around the center axis is 0.9 mm (more preferably 0.5 mm or less), and are also especially suitable for a sleeve unit and a motor having a sleeve in which depth of the groove in the radial direction is 10% or more of the thickness of the sleeve.

To ensure the temperature margin of the tapered seal in the lower gap 43a, and to secure the dynamic pressures of the first upper gap 41a and the second upper gap 41b, the number of grooves 2213 should not be excessively high. Thus, the preferable number of grooves 2213 of the three phase drive motor 1a is seven (or five like the first embodiment).

Although the embodiments of the invention have been explained above, the invention is not limited to the embodiments, and the invention may variously be modified.

### Other Embodiments

In the motor 1a of the first embodiment, like the second embodiment, the tip end (lower end) of the shaft 311 may be provided with a disk-like thrust plate. In this case, in the sleeve unit 22, a gap greater than the lower gap 43 is provided between a lower end surface of the sleeve 221 and an inner bottom surface of the sleeve housing 222, and an outer edge of the thrust plate is disposed in the gap. A groove for generating fluid dynamic pressure is formed in a lower end surface of the sleeve 221, and a thrust dynamic pressure bearing portion is formed in a gap between an upper surface of the thrust plate and a lower end surface of the sleeve 221. It is not always necessary that the sleeve housing 222 is integrally formed, and the sleeve housing 222 may comprise a cylindrical sidewall portion and a disk-like bottom portion which closes a lower opening of the sidewall portion.

In the bearing mechanism of the motor, it is unnecessary to always limit the number of grooves 2213 forming the flow paths for circulating lubricant oil to five or seven, and the number may be changed within a range where the number becomes a relative prime with respect to the number of phase of the drive current of the motor and the number of poles of the field magnet 34. For example, three grooves 2213 may be formed in the sleeve outer surface 2212 of a two phase drive motor, or three to seven grooves 2213 may be provided in a five phase drive motor.

It is not always necessary that the grooves 2213 are utilized as the flow paths for circulating lubricant oil, and may be utilized as venting paths for securing passage of air between the outside and the space in the sleeve housing when the sleeve is mounted on the sleeve housing.

It is not always necessary that the sleeve of the embodiment is a porous member formed by pressurizing and forming the raw material and then sintering the same. The sleeve may be made of solid material. The bearing mechanism of the embodiment may use a so-called air dynamic pressure bearing using air as working fluid.

It is not always necessary that the motor of the embodiment is the so-called outer rotor type motor in which the field magnet 34 is disposed outside of the armature 24. The motor may be of an inner rotor type in which the field magnet 34 is disposed on the side of the center axis J1 of the armature 24. The motor may be utilized as a drive source of a drive other then the hard disk drive, such as a recording disk drive (e.g., removable disk drive). The motor may be utilized as an industrial motor other than the drive source of the recording disk drive.

What is claimed is:

1. A K-phase electric motor comprising:
a rotor portion having a P-poles field magnet disposed around a shaft formed on a center axis;
a stator portion having a S-slots armature for generating torque around the shaft between the stator portion and the field magnet, and that supports the rotor portion such that the rotor portion can rotate around the shaft;
a sleeve including a substantially cylindrical inner surface formed around the center axis into which the shaft is inserted, and a substantially cylindrical outer surface formed around the center axis, the outer surface being provided with a plurality of straight grooves that are substantially in parallel to the center axis and that are arranged at substantially equal distances from each other with respect to a circumferential direction around the center axis;
a sleeve housing in which the outer surface of the sleeve is fixed to and mounted on an inner surface of the sleeve housing; and
a sleeve unit of a bearing mechanism utilizing fluid dynamic pressure comprising the sleeve and the sleeve housing, wherein:
a number of the grooves of the outer surface of the sleeve is a relative prime with respect to the number of phase (K) of drive current of the motor and the number of poles (P) of the field magnet.

2. The K-phase electric motor according to claim 1, wherein:
the number of phase (K) is three; and
the number of grooves of the sleeve is five or seven.

3. The three-phase electric motor according to claim 2, wherein the sleeve is formed in such a manner that a raw material is pressurized and formed and then sintered.

4. The three-phase electric motor according to claim 3, wherein a thickness of the sleeve in the radial direction around the center axis is 0.9 mm or less.

5. The three-phase electric motor according to claim 4, wherein depths of the grooves of the sleeve in the radial direction around the center axis are 10% or less of the thickness.

6. The K-phase electric motor according to claim 1, wherein the sleeve housing is substantially bottomed cylindrical.

7. The K-phase electric motor according to claim 6, wherein:
the sleeve is formed by pressurizing and forming raw material and then by sintering the same;
a thickness of the sleeve in the radial direction around the center axis is 0.9 mm or less; and
depths of the grooves of the sleeve in the radial direction around the center axis are 10% or more of the thickness.

8. The K-phase electric motor according to claim 7, wherein:
the number of phase (K) is three; and
the number of grooves is five or seven.

9. The K-phase electric motor according to claim 6, wherein:
a plurality of flow paths are formed by the grooves of the sleeve and the inner surface of the sleeve housing; and
the flow paths are utilized for circulating working fluid in the bearing mechanism.

10. The K-phase electric motor according to claim 9, wherein:
the sleeve is formed by pressurizing and forming raw material and then by sintering the same;
a thickness of the sleeve in the radial direction around the center axis is 0.9 mm or less; and
depths of the grooves in the radial direction around the center axis are 10% or more of the thickness.

11. The K-phase electric motor according to claim 10, wherein:
the number of phase (K) is three; and
the number of grooves is five or seven.
